(19) United States
(12) Patent Application Publication
(10) Pub. No.: US 2010/0291323 A1
(43) Pub. Date: Nov. 18, 2010

(54) INKJET RECORDING MEDIUM AND METHOD FOR MANUFACTURING THE SAME

(76) Inventors: Masafumi Wasai, Tokyo (JP); Masaya Tosaka, Tokyo (JP); Hiroshi Koyamoto, Tokyo (JP); Kei Takigawa, Tokyo (JP); Takayuki Sato, Tokyo (JP); Atsushi Ono, Tokyo (JP); Yoshio Yoshida, Tokyo (JP)

Correspondence Address: JENKINS, WILSON, TAYLOR & HUNT, P. A., 3100 Tower Blvd., Suite 1200, DURHAM, NC, 27707, US

(21) Appl. No.: 12/680,677

(22) PCT Filed: Sep. 29, 2008
(86) PCT No.: PCT/JP2008/067610

§ 371 Date: May 27, 2010

(30) Foreign Application Priority Data
Sep. 29, 2007 (JP) 2007-256918
Oct. 22, 2007 (JP) 2007-273335
Nov. 1, 2007 (JP) 2007-284946

(51) Int. Cl. B32B 5/16; B05D 1/36

(52) U.S. Cl. 428/32.18; 427/411

(57) ABSTRACT

An inkjet recording medium comprising an ink-receiving layer containing a pigment and a binder formed on at least one side of a base paper containing calcium carbonate as a filler and pulp by a cast coating method, wherein the ash content of the calcium carbonate in the base paper is 15-30% by mass, and the ink-receiving layer contains colloidal silica as the pigment having a primary particle diameter of 30-70 nm and a ratio of the secondary particle diameter to the primary particle diameter of 1.5-3.0.

### FIELD OF THE INVENTION

The present invention relates to a high-gloss inkjet recording medium and a method for manufacturing the same.

### DESCRIPTION OF THE RELATED ART

An inkjet recording medium comprises an ink-receiving layer containing a pigment such as silica and alumina, and a binder on a surface of a support such as a paper such that ink droplets are fixed on the ink-receiving layer. The recording medium used for inkjet recording medium is roughly classified into a non-coated paper type having a texture like quality paper and PPC paper, and a coated paper type obviously including an ink receiving layer. The coated paper type recording medium is further roughly classified into a gloss type having a gloss ink-receiving layer, and a matte type having non-gloss ink-receiving layer. Along with the remarkable progress in inkjet printers and widely spread digital cameras in recent years, a quality level required for the inkjet recording medium is demanding year after year. In particular, a quality is strictly required for inkjet recording medium approaching the quality of conventional silver halide photographs, and the technology development is enormously encouraged.

Such a high-gloss inkjet recording medium is commonly produced by a cast coating method using a cast coater in view of manufacturing costs. The cast coating method involves applying a coating color containing a pigment and a binder as major components to a base paper to form a coating layer, and providing the coating layer with a gloss finish using a cast drum. The gloss coating layer becomes the ink-receiving layer. Three types of cast coating methods are generally known: (1) a wet casting (direct) method in which the coating layer in a wet state is pressed against a heated specular finish surface of a drum and then dried, (2) a re-wetting method in which the coating layer in a wet state is dried or semi-dried, then swelled and plasticized with a re-wetting agent, and is pressed against a heated specular finish surface of a drum and then dried, and (3) a gel casting (solidify) method in which the coating layer in a wet state is gelled by solidification, and is pressed against a heated specular finish surface of a drum and then dried. The principle of each method is the same in that the coating layer in a wet state is pressed against a specular finish surface to provide gloss to the surface of the coating layer.

Quality characteristics required for the gloss inkjet recording medium includes a high ink drying speed, a high-gloss recording medium surface, a high optical density, no ink overflow or bleeding, less uneven printing (contrasting density) or the like. In order to enhance these characteristics, the ink-receiving layer is improved. For example, it is reported that one or more ink-receiving layers are used, and at least one of which contains colloid particles having a mean particle diameter of 300 nm or less and a cationic resin (see, for example, Patent Literatures 1 and 2).

Also, it is reported that uneven printing is prevented by using colloidal silica having a primary particle diameter of 30-100 nm and a ratio of the secondary particle diameter to the primary particle diameter of 1.5-2.5 in a cast coating layer (see, for example, Patent Literatures 3 and 4).

In addition, it is reported that a high-gloss inkjet recording paper that causes less uneven printing is provided by disposing a cast coating layer on a base paper having an ash content of 13.5% (see, for example, Patent Literature 5).

Moreover, there is disclosed an inkjet recording paper comprising a base paper containing pulp and a filler mainly containing rosette type precipitated calcium carbonate having an average particle diameter of 1.6 μm or more and an oil absorption of 90-200 ml/100 g, and one or more ink-receiving layers containing a pigment and a binder disposed on at least one side of the base paper in which an ash content of the base paper measured according to JIS-P8251 is 15-40% (see, for example, Patent Literature 6).

A high-gloss inkjet recording cast coating paper containing synthetic silica and colloidal silica is also known. It is also reported that the cast coating layer contains silica fine particles having a primary mean particle diameter of 3-40 nm and a secondary mean particle diameter of 10-400 nm and colloidal silica having a mean particle diameter of 200 nm or less (see, for example, Patent Literatures 7 and 8).

There is also reported that a high-gloss and scratch-proof inkjet recording sheet comprising a gloss ink-receiving layer containing an ultrafine pigment such as colloidal silica and a binder as major components disposed on a support, and a gloss protective layer containing an ultrafine pigment and a binder as major components disposed thereon with a dry coating weight of 0.02-0.5 g/m² (see, for example, Patent Literature 9).

### [Patent Literature 1] Unexamined Japanese Patent Publication (Kokai) 2004-209965

### [Patent Literature 2] Unexamined Japanese Patent Publication (Kokai) Hei 09-263039

### [Patent Literature 3] Unexamined Japanese Patent Publication (Kokai) 2004-270104

### [Patent Literature 4] Unexamined Japanese Patent Publication (Kokai) 2005-35169

### [Patent Literature 5] Unexamined Japanese Patent Publication (Kokai) Hei 04-195795 (Table 1, [0118])

### [Patent Literature 6] Unexamined Japanese Patent Publication (Kokai) 2006-256001

### [Patent Literature 7] Unexamined Japanese Patent Publication (Kokai) Hei 02-274587

### [Patent Literature 8] Unexamined Japanese Patent Publication (Kokai) 2000-85242

### [Patent Literature 9] Unexamined Japanese Patent Publication (Kokai) 2007-136777

### PROBLEMS TO BE SOLVED BY THE INVENTION

Patent Literatures 3 and 5 mention that uneven printing is improved when a dye ink is used (the inkjet printers PM950C and PM970C used in Examples in these Patent Literatures use a dye ink), but do not mention that the printability (as to optical density and uneven printing) is improved when a pigment ink is used.

In the case of the technology described in Patent Literatures 2 and 4, there is a room for improvement in terms of providing the recording medium with high gloss, and there is a problem that uneven printing may appear when inkjet recording is conducted using a pigment ink. The term “uneven printing” refers to uneven contrasting density appeared when a solid portion is printed by an inkjet recording method, and it is contemplated that the uneven printing may be induced by cracks on the surface of the ink-receiving layer. In the case of the technology described in Patent Literature 4, uneven printing can be prevented when a dye ink is used, since no relatively large cracks exist on the surface of the ink-receiving layer, but remaining minor fissures still cause uneven printing (such as decoloration in the solid printed portion and blotchy uneven density) when a pigment ink is used.

In the case of the technology described in Patent Literature 6, high degree gloss cannot be obtained, since the ink-receiving layer is not provided by using a cast coating method although the base sheet contains rosette type precipitated calcium carbonate having high ash content.

In the case of the technology described in Patent Literatures 7 to 9, some high-gloss inkjet recording medium can be obtained, but the gloss is not so high that is comparable to silver halide photographs. If trying to provide a high-gloss inkjet recording medium using the technology described above, the amount of the binder in the ink-receiving layer should be increased, which may result in the reduction of ink absorption performance.

In the case of the technology described in Patent Literature 9, the ink-receiving layer and the gloss protective layer should be separately cast coated, which leads to poor production efficiency.

Therefore, the object of the present invention is to provide an inkjet recording medium having high gloss and excellent printability (as to optical density and no uneven printing) using a pigment ink.

The other object of the present invention is to provide a method for manufacturing an inkjet recording medium having high gloss, excellent printing quality and operability.

### SUMMARY OF THE INVENTION

As described above in relation to Patent Literature 3, the present inventors found that the uneven printing is caused by fine cracks on the surface of the coating layer applied by a cast coating method and that the uneven printing can be prevented by using the predetermined colloidal silica when a dye ink is used. In addition, the present inventors figured out the inherent problem of the pigment ink. That is, using the pigment ink in poor absorption performance of a ink-receiving layer, a coloring pigment is aggregated due to surface tension while the solvent of the pigment ink is retained in the ink-receiving layer, which leads to uneven printing.

Through diligent studies, the present inventors solved the problems described above by using as a pigment colloidal silica having a predetermined primary particle diameter and a secondary particle diameter, and using as a filler calcium carbonate with an ash content of 15-30% in the base paper.

Also, through diligent studies, the present inventors found that when rosette type precipitated calcium carbonate is contained as a filler in a base paper having air permeability, excellent gloss can be added to the ink-receiving layer formed by the cast coating method. It is also found that the use of the rosette type precipitated calcium carbonate as a filler can prevent the uneven printing when a pigment ink is used.

Further, through diligent studies about the method for manufacturing an inkjet recording medium, the present inventors discovered that when gloss is added to the ink-receiving layer using a cast coating method, the above-mentioned problems can be solved by applying an aqueous solution containing a cationic urethane resin, and then contacting the surface of the coating layer with a cast drum (heated specular finish surface), and thus accomplished the present invention.

A first aspect in accordance with the present invention provides an inkjet recording medium comprising an ink-receiving layer containing a pigment and a binder formed on at least one side of a base paper containing calcium carbonate as a filler and pulp by a cast coating method, wherein the ash content of the calcium carbonate in the base paper is 15-30% by mass, and the ink-receiving layer contains colloidal silica as the pigment having a primary particle diameter of 30-70 nm and a ratio of the secondary particle diameter to the primary particle diameter of 1.5-3.0.

Preferably, the content of the colloidal silica is 20-80% by mass based on the total pigment in the ink-receiving layer.

Preferably, the calcium carbonate in the base paper is rosette type precipitated calcium carbonate and the ink-receiving layer has gloss of 10% or more at 20 degree measured according to JIS-Z8741.

Preferably, the ash content of the rosette type precipitated calcium carbonate in the base paper is 5-25% by mass measured according to JIS-P8251.

A second aspect in accordance with the present invention provides a method for manufacturing an inkjet recording medium comprising the steps of: applying a coating color for an ink-receiving layer containing a pigment and a binder on at least one side of a base paper containing calcium carbonate as a filler and pulp to form a coating layer; applying an aqueous solution containing from 0.01% by mass to 1% by mass of a cationic urethane resin; and contacting the surface of the coating layer with a heated specular finish surface to form a gloss ink-receiving layer, wherein the ash content of the calcium carbonate in the base paper is 15-30% by mass, and the ink-receiving layer contains colloidal silica as the pigment having a primary particle diameter of 30-70 nm and a ratio of the secondary particle diameter to the primary particle diameter of 1.5-3.0.

Preferably, the binder in the coating color for the ink-receiving layer contains poly(vinyl alcohol) and the aqueous solution further contains boric acid and/or borax.

Preferably, the aqueous solution is applied to the coating layer in a wet state.

According to the present invention, there is provided an inkjet recording medium having high gloss and excellent printability (optical density and no uneven printing) using a pigment ink.

According to the method for manufacturing an inkjet recording medium of the present invention, there is provided an inkjet recording medium having high gloss, excellent printing quality (color development and ink absorption performance) and operability.

### BRIEF DESCRIPTION OF THE DRAWING

FIG. 1 is an electron micrograph showing a shape of secondary particles in rosette type precipitated calcium carbonate.

### DESCRIPTION OF THE PREFERRED EMBODIMENTS

Embodiments of the present invention are explained below. An inkjet recording medium of the present invention is obtained by forming an ink-receiving layer containing a pigment and a binder on at least one side of a base paper by a cast coating method.

### (Base Paper)

Base paper for use in the present invention is a coated paper or a non-coated paper both having air permeability so that water vapor produced on a cast drum upon a cast coating method can be passed. Raw material pulp for the paper includes chemical pulp (for example, bleached or unbleached softwood kraft pulp, bleached or unbleached hardwood kraft pulp), mechanical pulp (for example, ground pulp, thermomechanical pulp and chemithermomechanical pulp), and deinking pulp. These can be used alone or in combination in any ratio. In the present invention, raw material pulp preferably contains softwood pulp. A use of softwood pulp in the base paper enhances the strength of the base paper, and tends to increase gloss in the ink-receiving layer. However, if a large amount of softwood pulp is used, the surface properties of the base paper may declined. The content of softwood pulp is preferably 30% by mass or less based on the total amount of the pulp. Meanwhile, the pH of the paper may be acidic, neutral and alkaline.

Preferably, the base paper has air permeability of 1000 seconds or less from the standpoint of the production efficiency of the inkjet recording medium, and has Stockigt size degree of 5 seconds or more from the standpoint of cotability.

### (Filler)

The base paper contains calcium carbonate as a filler. The ash content of the calcium carbonate is 15-30% by mass. The high ash content in calcium carbonate can prevent uneven printing when a pigment ink is used. Although the reason for this is unclear, it is believed as follows:

When the ink-receiving layer contains colloidal silica specified below, large cracks on the surface of the ink-receiving layer formed by a cast coating method can be suppressed. And when the ash content of calcium carbonate is 15-25% by mass in the base paper, binder components in the coating color for the ink-receiving layer are soaked uniformly into the base layer upon applying the coating color for the ink-receiving layer to the base paper. Thereby, minor fissures (small cracks) on the surface of the ink-receiving layer are suppressed. As a result, few cracks exist on the surface of the ink-receiving layer, and uneven printing upon printing with a pigment ink can be significantly decreased. And since no surface cracks exist, the pigment uniformly exists in the ink-receiving layer and high ink absorption performance can be held. It is also possible to prevent uneven printing due to aggregation of the coloring pigment induced by surface tension.

When the ash content of calcium carbonate in the base paper is under 15%, fine surface cracks described above are produced and significant uneven printing upon printing with a pigment ink is induced. The higher the ash content of calcium carbonate in the base paper is, the more effective the uneven printing upon printing with a pigment ink is prevented. However, when the ash content of calcium carbonate in the base paper exceeds 30%, powder may drop and the strength of the base paper may be decreased. In view of the balance between manufacturing costs and effectiveness, the ash content is preferably 25% by mass or less.

The ash content can be measured according to JIS-P8251.

The calcium carbonate is fine particle having a mean particle diameter of 0.1 to 5 μm. There are ground calcium carbonate obtained by mechanically grinding limestone, and precipitated calcium carbonate obtained by synthesizing such as reacting calcium chloride and soda ash. Both of them can be used. Preferably, precipitated calcium carbonate is used in the present invention, since fine particles having uniform size and shape is easily provided.

Known fillers including hydrated silicate, white carbon, talc, kaolin, clay, calcium carbonate, titanium oxide, synthetic resin particles and the like can be selected and used in combination with calcium carbonate as needed, so long as they do not interfere with the effect of the present invention. In order to provide the base paper having high brightness at a low cost, the amount of the filler other than calcium carbonate is preferably 30% by mass or less based on the total amount of the filler. More preferably, the filler other than calcium carbonate is not included.

### (Rosette Type Precipitated Calcium Carbonate)

Preferably, calcium carbonate contains rosette type precipitated calcium carbonate. The rosette shape may refers to a form where spindle shaped primary particles of precipitated calcium carbonate are radially aggregated into rosette type secondary particles. Specific examples include ALBACAR-HO, ALBACAR-5970 and ALBACAR-LO sold by Specialty Minerals Inc. The term “radially” means that each primary particle grows radially in a longitudinal direction from a point near the center of each secondary particle.

The precipitated calcium carbonate is excellent in view of manufacturing costs and operability. Also, high opacity can be provided by adding only a small amount of it. When the base paper contains a high amount of the rosette type precipitated calcium carbonate having a particular shape, the opacity of the base paper is significantly enhanced to prevent strike-through of inkjet recording effectively. The rosette type precipitated calcium carbonate has a higher specific surface area than that of conventional precipitated calcium carbonate, such that the base paper having excellent ink absorption performance is obtained. Especially when the ink-receiving layer has less coating weight, the use of the rosette type precipitated calcium carbonate provide a great deal of benefits.

The mean particle diameter of the rosette type precipitated calcium carbonate is preferably 1.5 μm to 5.0 μm. When the mean particle diameter is under 1.5 μm, light permeability is enhanced to decrease the opacity of the base paper. As a result, the printed image may be seen through the rear surface of the paper, or strike-through may occur. When the mean particle diameter exceeds 5.0 μm, the filler is nonuniformly distributed to decrease the opacity of the base paper, which may leads to strike-through and decreased quality stability.

The rosette type precipitated calcium carbonate has preferably oil absorption of 90-200 ml/100 g, and more preferably 90-140 ml/100 g. When the oil absorption is under 90 ml/100 g, the ink absorption performance of the resulting inkjet recording medium declines. When the same exceeds 200 ml/100 g, the absorption performance becomes too great to permeate only the binder components into the base paper, when the coating color for the ink-receiving layer is applied. As a result, the surface strength of the ink-receiving layer declines, and powder may drop when trimming.

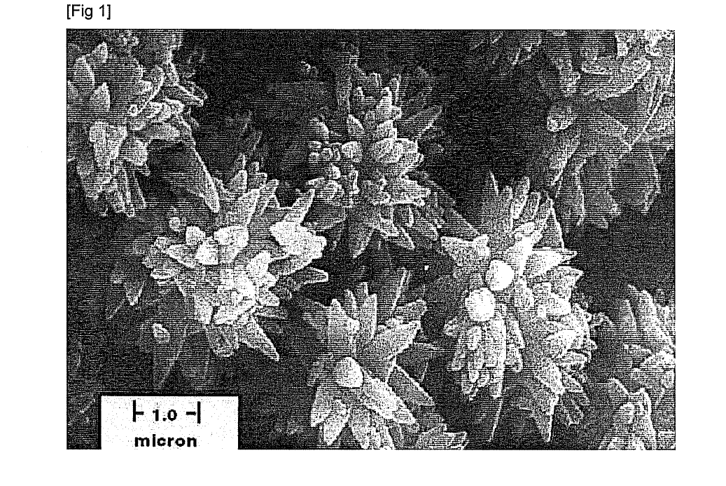

FIG. 1 is an electron micrograph showing an example of the rosette type precipitated calcium carbonate (secondary particles) dispersed in the liquid. In the FIGURE, the bottoms of the primary particles are aggregated and the primary particles grow radially to their tips. The primary particles have some large wide (diameter) bottoms and become thin toward the tips. In the FIGURE, the micron means μm.

When the ink-receiving layer is formed on the base paper containing rosette type precipitated calcium carbonate as a filler by a cast coating method, gloss at 20 degree measured according to JIS-Z8741 on the ink-receiving layer is enhanced as compared with that formed on the base paper containing no rosette type precipitated calcium carbonate as a filler. Although, the reason is not clear, it is believed as follows:

If the rosette type precipitated calcium carbonate is added to the base paper, the density of the base paper decreases to be bulky and improve cushioning characteristics. When the coating layer for the ink-receiving layer is pressed to the cast drum upon the cast coating method, the coating layer becomes in close contact with the surface of the cast drum. As a result, it is believed that the high-gloss ink-receiving layer can be obtained. When the value of gloss at 20 degree is high, it can provide excellent gloss. In the present invention, the gloss at 20 degree is preferably 10% or more. Also, the high image clarity leads to high gloss. In the present invention, the image clarity is preferably 40% or more, and more preferably 60% or more.

Preferably, the density of the base paper is 0.8 or less.

If the rosette type precipitated calcium carbonate is added to the base paper, uneven printing upon printing with a pigment ink can be prevented. The reason is presumed as follows.

The cause of the uneven printing may be fine cracks and fissures on the surface of the ink-receiving layer. It is believed that the binder components in the ink-receiving layer are soaked nonuniformly into the base paper upon applying the coating color for the ink-receiving layer to the base paper, thereby inducing minor fissures (small cracks) on the surface of the ink-receiving layer. In particular, these minor fissures induce uneven printing upon printing with a pigment ink.

In contrast, when the base paper contains rosette type precipitated calcium carbonate, the absorption performance of the base paper is improved. It is contemplated that the binder components in the ink-receiving layer are soaked uniformly into the base paper, thereby suppressing fissures (small cracks). As a result, uneven printing upon printing with a pigment ink can be decreased. Also, since the color is uniformly soaked into the base paper, the pigment uniformly exists in the ink-receiving layer and high ink absorption performance can be held. As a result, the aggregation of coloring pigment by surface tension and uneven printing due to the selective absorption of coloring pigment into the cracks are suppressed while the solvent of the pigment ink is held in the ink-receiving layer.

Moreover, when the ink-receiving layer contains colloidal silica having a predetermined primary particle diameter and a ratio (secondary particle diameter/primary particle diameter) as described later, large cracks on the surface of the ink-receiving layer can be suppressed and uneven printing upon printing with a pigment ink can further decreased.

### (Ash Content)

The ash content of the rosette type precipitated calcium carbonate in the base paper measured according to JIS-P8251 is preferably 5-25% by mass, and more preferably 10-20% by mass. The high ash content of calcium carbonate in the base paper significantly improve gloss on the surface of the ink-receiving layer formed by a cast coating method, and suppress uneven printing upon printing with a pigment ink.

When the ash content of the rosette type precipitated calcium carbonate is under 5% by mass, gloss may not be so improved. The high ash content of rosette type precipitated calcium carbonate improves gloss and suppresses uneven printing. But, when the ash content exceeds 25% by mass, powder may drop and the strength of the base paper may be decreased. Accordingly, in light of the balance between manufacturing costs and effectiveness, the ash content of the rosette type precipitated calcium carbonate is preferably not exceeding 25% by mass.

According to JIS-P8251, the ash content is expressed by percentage of a residue weight of ash after burning at a temperature of 525+/−25° C. to absolute dry weight of a sample.

Known fillers including hydrated silicate, white carbon, talc, kaolin, clay, calcium carbonate (other than rosette type precipitated calcium carbonate), titanium oxide, synthetic resin particles and the like can be selected and used in combination with the rosette type calcium carbonate as needed, so long as they do not interfere with the effect of the present invention. The amount of the filler other than the rosette type calcium carbonate is preferably 30% by mass or less based on the total amount of the filler in the base paper. More preferably, no filler other than the rosette type calcium carbonate is included.

### (Pigment in the Ink-Receiving Layer)

The ink-receiving layer contains colloidal silica as the pigment having a primary particle diameter of 30-70 nm and a ratio of the secondary particle diameter to the primary particle diameter of 1.5-3.0. When the primary particle diameter of colloidal silica is under 30 nm, the transparency of the ink-receiving layer is high, but fine cracks are produced on the surface of the coating layer, which induces uneven printing upon printing with a pigment ink to decrease the optical density. With the large primary particle diameter, the cracks and uneven printing upon printing with a pigment ink may be reduced.

Especially when the printing is performed by the inkjet printer using a pigment ink containing coloring particles each having particle diameter of about 30 to 150 nm, it is effective that the primary particle diameter of the colloidal silica is 30 nm or more.

On the other hand, when the primary particle diameter exceeds 70 nm, transparency of the ink-receiving layer is decreased and optical density when the printing is performed with a dye ink is significantly decreased, resulting in poor dye ink printability.

When a ratio of the secondary particle diameter to the primary particle diameter is under 1.5, the ink absorption of the ink-receiving layer is decreased. When the same exceeds 3.0, the gloss of the ink-receiving layer is decreased. The primary particle diameter of colloidal silica can be measured by BET method. The secondary particle diameter can be measured by dynamic light scattering.

By observing the dispersed state of colloidal silica used in the present invention with a microscope, there is a multitude of two to three spherical single colloidal silica particles (primary particle) connected. For convenience, these are referred to as “peanut-shaped” silica. The average value of the number of connected primary particles roughly corresponds to the above-described ratio. The colloidal silica used in the present invention does not include the silica mainly involves chain (or pearl necklace-shaped) colloidal silica or mainly involves cluster colloidal silica (by the microscopic observation, at least five, and generally 10 or more spherical single colloidal silica particles are aggregated; the ratio is 5 or more). The term “not include” herein does not means that cluster colloidal silica is never observed by microscope, but means that some cluster colloidal silica may be observed but the ratio of the secondary particle diameter to the primary particle diameter, which is a macroscopic physical property, does not exceed 3.

The colloidal silica is synthesized by sol-gel process using alkoxysilane as a raw material. The primary particle diameter (BET method particle diameter) and the secondary particle diameter (dynamic scattering particle diameter) are preferably controlled by the synthesis conditions. It is not preferable to use ground silica having the secondary particle diameter adjusted by mechanically grinding the synthesized silica. An example of the colloidal silica preferably used in the present invention includes Quartron series manufactured by Fuso Chemical Co., Ltd.

The colloidal silica is preferably added in amount of 20 to 80 parts by mass, and more preferably 30 to 70 parts by mass based on 100 parts by mass of the all pigments in the ink-receiving layer. When the amount of the colloidal silica is under 20 parts by mass based on the total amount of the pigment, not only gloss is reduced, but also ink absorption performance and color development upon inkjet printing become insufficient. Also, uneven printing may not be improved. When the amount of the colloidal silica exceeds 80 parts by mass, coating operability may be decreased.

As the pigment other than the above-mentioned colloidal silica in the ink-receiving layer, synthesized amorphous silica can be used. Synthesized amorphous silica is roughly classified into wet silica and fumed silica depending on the production method. Wet synthesized amorphous silica has lower pigment transparency than fumed silica, but has excellent coating material stability when poly(vinyl alcohol) is used in combination. Also, wet silica has good dispersibility as compared with gas-phase silica having no internal void, and it is possible to increase coating material concentration. Accordingly, the percentage of the pigment in the ink-receiving layer (to the binder) can be high to increase the absorption performance of the ink-receiving layer. Thus, the ink absorption performance and the color development of the dye ink can be improved. In terms of obtaining high gloss, the secondary particle diameter of the synthesized amorphous silica (synthesized silica other than colloidal silica) is preferably 1 to 5 μm. Preferably, a BET specific surface area is 150-500 m²/g.

When the percentage of the synthesized amorphous silica is increased to the all pigments in the ink-receiving layer, the ink absorption performance is improved, but the coloring pigment easily enters into the inside of the ink-receiving layer, whereby an improvement in the color development tends to be insufficient when the pigment ink is used for printing. When the percentage of the synthesized amorphous silica is decreased, the ink absorption performance tends to be decreased, resulting in great uneven printing.

Most preferably, a mixture of the above-mentioned colloidal silica and the synthesized amorphous silica is used as the pigment in the ink-receiving layer. When the ink-receiving layer contains the synthesized amorphous silica other than the peanut-shaped colloidal silica, the synthesized amorphous silica (other than the peanut-shaped colloidal silica) is preferably added in amount of 20 to 80 parts by mass, and more preferably 30 to 70 parts by mass based on 100 parts by mass of the all pigments in the ink-receiving layer.

As the pigment in the ink-receiving layer other than the colloidal silica, other pigment including aluminum hydroxide, alumina sol, colloidal alumina, alumina such as pseudo-boehmite (a-type crystal alumina, 8-type crystal alumina, y-type crystal alumina), alumina hydrate, synthesized silica, kaolin, talc, calcium carbonate, titanium oxide, clay and zinc oxide may be used in combination, so long as the ink absorption performance, the color development and the gloss are not interfered upon inkjet recording.

### (Binder in the Ink-Receiving Layer)

As the binder in the ink-receiving layer, polymer compounds capable of forming a film can be used. For example, as the binder, starch, starch oxide, esterified starch and the like; cellulose derivatives such as carboxymethyl cellulose, hydroxyethyl cellulose; poly(vinyl alcohol); poly(vinyl pyrrolidone); casein; gelatin; soy protein; styrene-acrylic resin and their derivatives; styrene-butadiene resin, acrylic resin, vinyl acetate resin, vinyl chloride resin, urethane resin, urea resin, alkyd resin and their derivatives can be used alone or in combination. The binder is preferably added in amount of 5 to 30 parts by mass based on 100 parts by mass of the all pigments in the ink-receiving layer. However, the amount is not especially limited as long as the needed strength of the coating layer can be provided.

The polymer compound used as the binder is preferably aqueous. The term “aqueous” means that the resin is dissolved or dispersed and stabilized (water-soluble and/or water dispersible resin emulsion) in a medium consisting of water or water and a minor amount of an organic solvent. The binder is dissolved or dispersed as particles in the coating color to be applied to the support. After coating and drying, the binder acts on the pigment to form the ink-receiving layer.

In particular, as the aqueous polymer compound, partially saponified poly(vinyl alcohol) is preferably used. The poly(vinyl alcohol) is preferably added in amount of 3 to 30 parts by mass based on 100 parts by mass of the all pigments in the ink-receiving layer.

The ink-receiving layer contains the pigment and the binder as described above. Other components such as a thickener, an antifoaming agent, a foam inhibitor, a pigment dispersing agent, a mold release agent, a foaming agent, a pH adjusting agent, a surface sizing agent, a coloring dye, a coloring pigment, a fluorescent dye, an ultraviolet ray absorption agent, an antioxidant, a light stabilizer, a preservative, a water resistant additive, a dye fixing agent, a surfactant, a wet paper strengthening agent, a water retention agent, a cationic polymer electrolyte and the like can be added thereto within the ranges that do not adversely affect on the effect of the present invention.

A coating color can be applied to the base paper for forming the ink-receiving layer using any coating method as required by selecting a known on-machine or off-machine coater such as a blade coater, an air knife coater, a roll coater, a brush coater, a kiss coater, a squeeze coater, a curtain coater, a die coater, a bar coater, a gravure coater, a gate roll coater, a short dwell coater and the like.

The coating weight of the ink-receiving layer can be appropriately controlled in so far as the coating color cover the surface of the base paper and sufficient ink absorption performance is obtained. Preferably, the coating weight is 5-30 g/m², and more preferably 10-25 g/m² in terms of solid content from the standpoint of both sufficient recording density and ink absorption performance. When the coating weight exceeds 30 g/m², the coating layer is not well released from the specular finish surface of the cast drum and may be adhered to the specular finish surface.

In the present invention, if the high coating weight is required in the ink-receiving layer, a multilayer ink-receiving layer can be used. An undercoat layer having various features including the ink absorption performance, adhesion properties and the like may be disposed between the base paper and the ink-receiving layer. Moreover, a backcoat layer having various features including the ink absorption performance, writing properties, printability and the like may be disposed on the opposite surface of the base paper in which ink-receiving layer is disposed.

### (Formation of the Ink-Receiving Layer)

In the present invention, gloss is provided to the outermost ink-receiving layer by forming it with a cast coating method. The cast coating method is to press the coated surface in a wet state against a heated finish surface and to dry. A gel cast (solidify) coating method is preferably used to form the ink-receiving layer in that it can provide a sheet appearance and gloss approaching those of silver halide photographs.

The cast coating method is conducted as follows: A coating color for an ink-receiving layer is applied to a base paper to form a coating layer. Then, a treatment liquid for solidifying a binder (especially aqueous binder) in the coating color is applied to the coating layer to be wet. The coating layer in a wet state is pressed against a heated specular finish surface and dried to form the ink-receiving layer and to provide gloss thereon. When the treatment liquid is applied, the coating layer may be in a wet state or in a dry state. In the wet state, the specular finish surface is easily taking out to decrease minor asperities on the surface of the coating layer. Therefore, the resulting ink-receiving layer can be easily provided with gloss equal to that of silver halide photographs. The method for coating the treatment liquid includes roll, spray, curtain coating methods, but not limited to these methods.

A gel casting method will be described. After coating layer is applied in the above-described cast coating method, the undried coating layer is gelled with a solidifying liquid to be pressed against a heated specular finish surface and then dried. When the solidifying liquid is applied while the coating layer is in a dry state, it is difficult to take out the specular drum surface, resulting in a number of minor asperities on the ink-receiving layer. It is also difficult to provide gloss equal to that of silver halide photographs. Accordingly, the solidifying liquid is applied to the undried coating layer.

The solidifying liquid can solidify the aqueous binder in the coating layer, and calcium, zinc, and magnesium salts of formic acid, acetic acid, citric acid, tartaric acid, lactic acid, hydrochloric acid, sulfuric acid and the like are used. Especially when the aqueous binder is poly(vinyl alcohol), the solidifying liquid preferably contains boric acid and borate. A mixture of boric acid and borate can easily solidify the binder to the appropriate hardness, and can provide good gloss on the ink-receiving layer.

The method for coating the solidifying liquid is not especially limited as long as it can be applied to the coating layer, and can be selected as required from known methods (roll, spray, curtain coating methods and so on).

A release agent can be added to the coating layer and/or solidifying liquid as needed. The release agent has a melting point preferably of 90-150° C., and more preferably of 95-120° C. Within the above temperature range, the melting point of the release agent is almost equal to the temperature of the specular finish surface to maximize the performance of the release agent. Although the release agent is not especially limited as long as it has the above-mentioned properties, polyethylene type wax emulsion is preferably used.

A method for manufacturing the inkjet recording medium of the present invention will be described. The method for manufacturing the inkjet recording medium of the present invention comprises applying a coating color for an ink-receiving layer containing a pigment and a binder on at least one side of the above base paper to form a coating layer; applying an aqueous solution containing a cationic urethane resin; and contacting the surface of the coating layer with a heated specular finish surface to form a gloss ink-receiving layer.

In the method for manufacturing the inkjet recording medium of the present invention, the pigment colloidal silica has preferably a ratio of the secondary particle diameter to the primary particle diameter of 1.5-2.5.

As the pigment contained in the coating color for the ink-receiving layer, the above-mentioned colloidal silica and the synthesized amorphous silica may be used in combination. In this case, the ratio of the above-mentioned synthesized amorphous colloidal silica and the colloidal silica is as follows: (colloidal silica)/(synthesized amorphous silica) is preferably within 30/70 to 75/25, and more preferably within 40/60 to 70/30.

### (Cationic Aqueous Urethane Resin)

The coating color for the ink-receiving layer is applied to the support to provide the coating layer. The aqueous solution containing a cationic urethane resin is applied thereto to provide the coating layer in a wet state. In this way, the coating layer in a wet state after the aqueous solution application is pressed against a heated specular finish surface and dried to form the ink-receiving layer having high gloss. When the aqueous solution is used, the printability (color development and ink absorption performance) is improved. The reason is not clear, but it is contemplated that a great amount of the cationic urethane resin exist on the surface of the ink-receiving layer and the surface of the ink-receiving layer becomes cationic. In other words, when the surface of the ink-receiving layer is cationic, the coloring agent in the ink may stay near the surface of the ink-receiving layer to improve the optical density and suppress spreading of the ink in a cross direction, thereby decreasing the bleeding. It is also contemplated that the urethane resin has a polarity from a strong hydrogen bond, and can improve the printability (color development and ink absorption performance) unlike other resins.

When the aqueous solution is applied, the coating layer may be in a wet state or in a dry state. In the wet state, the specular finish surface is easily taking out to decrease minor asperities on the surface of the coating layer such that the resulting ink-receiving layer can be easily provided with gloss equal to that of silver halide photographs.

The cationic urethane resin is not especially limited, and can be selected from known aqueous cationic urethane resins as needed. The aqueous urethane resin is a polyurethane water dispersion obtained by basically introducing a hydrophilic component into a main chain of a polyurethane framework for stable dispersion in water, or being dispersed with an external emulsion.

In general, the urethane resin is a polymer obtained by reacting polyisocyanate with a polyol component such as polyether or polyester, and has a urethane group in a molecule. Further, the molecule may has a group other than the urethane group such as a buret group, an urea group and an arophanate group. Examples of the urethane resin preferably include a polyester-based urethane resin and a polyether-based urethane resin.

In the present invention, the urethane resin is preferably a self-emusification type in which a cationic hydrophilic component is directly introduced into a polyurethane skeleton, especially an ionomer type urethane resin. For example, the cationic urethane resin is obtained by introducing an amino group as a hydrophilic group for the self-emusification type urethane resin. Examples of the aqueous cationic urethane resin include HYDRAN CP series (CP-7030, CP-7020), PATERACOLE series (CA-101) and BONCOAT series (SFC-571) manufactured by DIC corporation, and SUPERFLEX™ series manufactured by Dai-ichi Kogyo Seiyaku Co., Ltd.

The cationic urethane resin in the aqueous solution has a concentration of 0.01% by mass to 1% by mass. When the concentration of the cationic urethane resin is under 0.01% by mass, the surface of the ink-receiving layer has insufficient gloss. When the same exceeds 1% by mass, the ink-receiving layer is difficult to be released from the cast drum to deteriorate the surface properties and to decrease gloss. Preferably, the cationic urethane resin has a concentration of 0.5% by mass or less from the standpoint of an improvement of the ink absorption performance.

The aqueous solution may be applied to the coating layer by any coating method such as a roll coating method, a spray coating method and a curtain coating method, but not limited to these methods.

Together with the cationic urethane resin, other components such as a thickener, an antifoaming agent, a foam inhibitor, a pigment dispersing agent, a mold release agent, a foaming agent, a pH adjusting agent, a surface sizing agent, a coloring agent, a fluorescent dye, an ultraviolet ray absorption agent, an antioxidant, a light stabilizer, a preservative, a water resistant additive, a dye fixing agent, a surfactant, a wet paper strengthening agent, a water retention agent, a cationic polymer electrolyte and the like can be added to the aqueous solution within the ranges that do not adversely affect on the effect of the present invention. Because gloss and the strength of the coating layer may be decreased, the aqueous solution preferably does not contain inorganic pigments (inorganic particles) such as colloidal silica. When anionic colloidal silica is added to the aqueous solution, it may aggregate with the cationic urethane resin by the difference in ionic character, which may lead to manufacturing impossible.

### (Cast Coating Method)

The glossy inkjet-receiving layer is formed using the cast coating method, i.e., by contacting the surface of the coating layer on which the aqueous solution is applied with the heated specular finish surface.

The cast coating method is to press the coating layer against the cast drum (the heated specular finish surface) and to dry it, thereby providing gloss to the coating layer.

Three types of cast coating methods are generally known: (1) a wet casting (direct) method in which the coating layer in a wet state is pressed against a heated specular finish surface of a drum and then dried, (2) a re-wetting method in which the coating layer in a wet state is once dried or semi-dried, then swelled and plasticized with a re-wetting agent, and is pressed against a heated specular finish surface of a drum and then dried, and (3) a gel casting (solidify) method in which the coating layer in a wet state is gelled by solidification, and is pressed against a heated specular finish surface of a drum and then dried.

The aqueous solution may be applied to the coating layer in the direct method, or may be used as a re-wetting liquid for the re-wetting method or as a solidifying liquid for the solidifying method.

In the re-wetting method, the aqueous solution is applied to the coating layer in a dry state. In this case, it is difficult to take out the specular drum surface, resulting in a number of minor asperities on the ink-receiving layer. It is also difficult to provide gloss equal to that of silver halide photographs. Accordingly, in the present invention, it is preferably used the direct method in which the aqueous solution is applied to the coating layer in a wet state, or the solidifying method in which the coating in a wet state is gelled in that it can provide a sheet appearance and gloss approaching those of silver halide photographs.

When the ink-receiving layer is formed using the gel casting method, the solidifying liquid contains a solidifying agent for solidifying (gelling) the binder in the ink-receiving layer and the above-mentioned cationic urethane resin. When the binder in the ink-receiving layer is poly(vinyl alcohol), the solidifying agent such as boric acid and borate and so on can be used. Examples of the borate include borax, orthoborate, diborate, metaborate, pentaborate and hexaborate, but no limited to these examples. Borax is preferable in view of costs and availability.

When boric acid and borate are used in combination, it is easy to provide appropriate hardness upon solidifying and good gloss can be provided to the ink-receiving layer. The ratio of boric acid and borate is preferably 0.25/1 to 2/1. When the ratio of borate/boric acid is under 0.25/1, an amount of boric acid becomes too high to solidify poly(vinyl alcohol) in the recording layer sufficiently. As a result, the coating layer that is poorly solidified may be adhered to the roll to which the solidifying liquid is applied, and the coating layer in a good wet state may not be obtained. On the other hand, when the ratio of borate/boric acid exceeds 2/1, poly(vinyl alcohol) in the coating layer is solidified hard. As a result, the surface of the ink-receiving layer may have low and uneven gloss.

The total concentration of the solidifying agent (borate and/or boric acid) in the aqueous solution can be adjusted as needed. When the total concentration of borate and/or boric acid in the aqueous solution becomes high, poly(vinyl alcohol) may be solidified too much and gloss tends to decrease. Also, when the total concentration is high, boric acid is easily precipitated in the treatment liquid to decrease the stability of the aqueous solution. The total concentration of borate and/or boric acid in the aqueous solution is preferably 1-5% by mass.

A release agent can be added to the coating color for the ink-receiving layer and/or the aqueous solution containing the cationic urethane resin as needed. The release agent has a melting point preferably of 90-150° C., and more preferably of 95-120° C. Within the above temperature range, the melting point of the release agent is almost equal to the temperature of the specular finish surface to maximize the performance of the release agent. Although the release agent is not particularly limited as long as it has the above-mentioned properties, polyethylene type wax emulsion is preferably used.

### EXAMPLES

The present invention is explained in further detail by presenting specific examples below, but the present invention is not limited by these examples. The terms “parts” and “%” refer to “parts by weight” and “% by mass”, respectively, unless otherwise noted.

A primary particle diameter and a ratio of a secondary particle diameter to a primary particle diameter of colloidal silica below are manufacturer's measured value (almost same as catalog values).

Embodiments of the inkjet recording medium of the present invention using precipitated calcium carbonate as the filler for the base paper will be shown with the following Examples 1 to 8 and Comparative Examples 1 to 4.

### Example 1

Precipitated calcium carbonate (TP-121, a trade name manufactured by Okutama Kogyo Co., Ltd.) was added in an ash content of 20% to a pulp slurry comprising 90 parts of bleached hard wood kraft pulp (L-BKP) and 10 parts of bleached soft wood kraft pulp (N-BKP) and having (Canadian standard freeness) freeness of 350 ml. 1.0 part of aluminum sulfate, 0.15 parts of AKD and 0.05 parts of a yield improving agent were further added thereto.

The slurry was processed with a paper machine to make a base material. On both surfaces of the base material, 5% of starch and 0.2% of a surface sizing agent (AKD) were applied at a solid content of 1.5 g/m² to provide a base paper having a weight of 180 g/m².

The following coating color A was applied in the solid content of 15 g/m² to one side of the resulting base paper using a roll coater. During the coating layer was in a wet state, the following solidifying liquid B was applied to solidify the coating layer. Then, the coating layer was pressed to a heated specular finish surface via a press roll to take out the specular surface, thereby providing an ink-jet recording medium having a weight of 195 g/m².

Coating color A: A coating color having a concentration of 25% was prepared by mixing, as pigments, 60 parts of colloidal silica (Quartron PL-5: a trade name manufactured by Fuso Chemical Co., Ltd., having a primary particle diameter of 50 nm and a ratio of the secondary particle diameter to the primary particle diameter of 2.2), 20 parts of gas-phase synthesized amorphous silica (Aerosil 200V manufactured by Nippon Aerosil Co., Ltd.), 20 parts of wet synthesized amorphous silica (Fine Seal X-37B manufactured by Tokuyama Corporation); as a binder, 12 parts of poly(vinyl alcohol) (PVA224, a trade name manufactured by Kuraray Co., Ltd.); 1.5 parts of a fluorescent dye (BLANKOPHOR P liquid 01: a trade name manufactured by LANXESS K.K.); 0.5 parts of a mold release agent (Meikatex HP68: a trade name manufactured by Meisel Chemical Works, Ltd.); and 0.1 parts of an antifoaming agent (SN Defoamer 480: a trade name manufactured by San Nopco Ltd.).

Solidifying liquid B: A solidifying liquid was prepared by mixing 2% of borax, 4% of boric acid (mass ratio of borax/boric acid=1/2, calculated based on Na₂B₄O₇ and H₃BO₃ conversion), 0.2% of malic acid, 0.5 parts of a mold release agent (Meikatex HP68: a trade name manufactured by Meisei Chemical Works, Ltd.), and 0.01% of an antifoaming agent (SN Defoamer 480: a trade name manufactured by San Nopco Ltd).

### Example 2

A coating color was prepared in the same manner described in Example 1 with the exception that colloidal silica (Quartron PL-3: a trade name manufactured by Fuso Chemical Co., Ltd., having a primary particle diameter of 30 nm and a ratio of the secondary particle diameter to the primary particle diameter of 2.3) was used in the coating color A in place of colloidal silica (Quartron PL-5: a trade name manufactured by Fuso Chemical Co., Ltd.), thereby providing an ink-jet recording medium.

### Example 3

A coating color was prepared in the same manner described in Example 1 with the exception that colloidal silica (Quartron PL-7: a trade name manufactured by Fuso Chemical Co., Ltd., having a primary particle diameter of 70 nm and a ratio of the secondary particle diameter to the primary particle diameter of 1.7) was used in the coating color A in place of colloidal silica (Quartron PL-5: a trade name manufactured by Fuso Chemical Co., Ltd.), thereby providing an ink-jet recording medium.

### Example 4

A coating color was prepared in the same manner described in Example 1 with the exception that the amount of colloidal silica (Quartron PL-5: a trade name manufactured by Fuso Chemical Co., Ltd.) was changed to 30 parts, and 30 parts of other colloidal silica (Quartron PL-3: a trade name manufactured by Fuso Chemical Co., Ltd., having a primary particle diameter of 30 nm and a ratio of the secondary particle diameter to the primary particle diameter of 2.3) was further added to the coating color A, thereby providing an ink-jet recording medium.

In Example 4, two types of colloidal silica were used. The dispersing states between particles in respective types of colloidal silica had no difference. Each of the primary particle diameter (secondary particle diameter) and a particle diameter ratio was reported by an average value obtained by weighing the content ratio of the combination.

### Example 5

A coating color was prepared in the same manner described in Example 1 with the exception that the amount of colloidal silica (Quartron PL-5: a trade name manufactured by Fuso Chemical Co., Ltd.) was changed to 40 parts, the amount of gas-phase synthesized amorphous silica (Aerosil 200V manufactured by Nippon Aerosil Co., Ltd.) was changed to 10 parts, and the amount of wet synthesized amorphous silica (Fine Seal X-37B manufactured by Tokuyama Corporation) was changed to 50 parts in the coating color A, thereby providing an ink-jet recording medium.

### Example 6

A coating color was prepared in the same manner described in Example 1 with the exception that the amount of colloidal silica (Quartron PL-5: a trade name manufactured by Fuso Chemical Co., Ltd.) was changed to 80 parts, the amount of gas-phase synthesized amorphous silica (Aerosil 200V manufactured by Nippon Aerosil Co., Ltd.) was changed to 10 parts, and the amount of wet synthesized amorphous silica (Fine Seal X-37B manufactured by Tokuyama Corporation) was changed to 10 parts in the coating color A, thereby providing an ink-jet recording medium.

### Example 7

A coating color was prepared in the same manner described in Example 1 with the exception that the amount of colloidal silica (Quartron PL-5: a trade name manufactured by Fuso Chemical Co., Ltd.) was changed to 20 parts, the amount of gas-phase synthesized amorphous silica (Aerosil 200V manufactured by Nippon Aerosil Co., Ltd.) was changed to 10 parts, and the amount of wet synthesized amorphous silica (Fine Seal X-37B manufactured by Tokuyama Corporation) was changed to 70 parts in the coating color A, thereby providing an ink-jet recording medium.

### Example 8

An ink-jet recording medium was provided in the same manner described in Example 1 with the exception that precipitated calcium carbonate (TP-121, a trade name manufactured by Okutama Kogyo Co., Ltd.) was added to change an ash content of 15% to the base paper.

### Comparative Example 1

A coating color was prepared in the same manner described in Example 1 with the exception that 60 parts of colloidal silica (Quartron PL-2: a trade name manufactured by Fuso Chemical Co., Ltd., having a primary particle diameter of 20 nm and a ratio of the secondary particle diameter to the primary particle diameter of 2.5) was used in the coating color A in place of colloidal silica (Quartron PL-5: a trade name manufactured by Fuso Chemical Co., Ltd.), thereby providing an ink-jet recording medium.

### Comparative Example 2

A coating color was prepared in the same manner described in Example 1 with the exception that 60 parts of colloidal silica (Quartron PL-10: a trade name manufactured by Fuso Chemical Co., Ltd., having a primary particle diameter of 100 nm and a ratio of the secondary particle diameter to the primary particle diameter of 2.1) was used in the coating color A in place of colloidal silica (Quartron PL-5: a trade name manufactured by Fuso Chemical Co., Ltd.), thereby providing an ink-jet recording medium.

### Comparative Example 3

An ink-jet recording medium was provided in the same manner described in Example 1 with the exception that precipitated calcium carbonate (TP-121, a trade name manufactured by Okutama Kogyo Co., Ltd.) was added to change an ash content of 13% to the base paper.

### Comparative Example 4

An ink-jet recording medium was provided in the same manner described in Example 1 with the exception that talc (IRK-085: a trade name manufactured by Iriki Kaolin Corporation) was added as a loading filler in an ash content of 15% to the base paper in place of precipitated calcium carbonate (TP-121, a trade name manufactured by Okutama Kogyo Co., Ltd.).

### <Evaluation>

1. Printability with a Pigment Ink

A predetermined pattern was recorded with the resulting inkjet recording medium using a pigment inkjet printer (PX-G900: a trade name manufactured by Seiko Epson Corporation), and was evaluated as follows:

1-1. Printing Clarity with Pigment Ink Printing (Optical Density)

Clarity on the predetermined pattern of the recorded image was visually evaluated. When the comprehensive evaluation result was 0 or above, there is no practical problem.

⊙: Very clear

### ◯: Clear

Δ: Slightly less clear
X: Not clear

### 1-2. Unevenness on the Pigment Ink Printed Area

The degree of the unevenness on the solid printed area was visually evaluated at four scales. The visually best (no unevenness) was ⊙, and the visually worst (significant unevenness) was X. When the evaluation result was A or more, there is no practical problem.

⊙: No unevenness
◯: Some unevenness

### Δ: Unevenness

X: Significant unevenness

### 2. Dye Ink Printability

A predetermined pattern was recorded with the resulting inkjet recording medium using a dye inkjet printer (PM-970C: a trade name manufactured by Seiko Epson Corporation), and clarity on the predetermined pattern of the recorded image was visually evaluated. When the comprehensive evaluation result was 0 or above, there is no practical problem.

⊙: Very clear

### ◯: Clear

Δ: Slightly less clear
X: Not clear

### 3. Gloss at 20 Degree

Gloss at 20 degree on the non-printed area of the surface of the ink-receiving layer in the resulting inkjet recording medium was measured according to JIS-Z8741. A gloss meter (True GLOSS GM-26PRO manufactured by Murakami Color Research Laboratory) was used for measurement. When the gloss at 20 degree is 20% or more, there is no practical problem, but is preferably 30% or more.

The results obtained are shown in Table 1.

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| Base | Loading filler | | Calcium | Calcium | Calcium | Calcium | Calcium | Calcium | Calcium |
| paper | | | carbonate | carbonate | carbonate | carbonate | carbonate | carbonate | carbonate |
| | Ash content (% by mass) | | 20 | 20 | 20 | 20 | 20 | 20 | 20 |
| Pigment in | Collidal silica | Trade name | Quartron | Quartron | Quartron | Quartron | Quartron | Quartron | Quartron |
| the ink- | | | PL-5 | PL-3 | PL-7 | PL-3,5 | PL-5 | PL-5 | PL-5 |
| receiving | | Primary | 50 | 30 | 70 | 40 | 50 | 50 | 50 |
| layer | | particle | | | | (Average | | | |
| | | diameter | | | | value) | | | |
| | | (nm) | | | | | | | |
| | | Secondary | 110 | 70 | 120 | 90 | 110 | 110 | 110 |
| | | particle | | | | (Average | | | |
| | | diameter | | | | value) | | | |
| | | (nm) | | | | | | | |
| | | Ratio of | 2.2 | 2.3 | 1.7 | 2.3 | 2.2 | 2.2 | 2.2 |
| | | particle | | | | (Average | | | |
| | | diameters | | | | value) | | | |
| | | Content | 60 | 60 | 60 | 60 | 40 | 80 | 20 |
| | | (parts) | | | | (Total) | | | |
| | Content of | Wet silica | 20 | 20 | 20 | 20 | 50 | 10 | 70 |
| | synthesized | Gas-phase | 20 | 20 | 20 | 20 | 10 | 10 | 10 |
| | amorphous | silica | | | | | | | |
| | silica (parts) | | | | | | | | |
| Evaluation | Gloss at 20 degree | | 35 | 30 | 35 | 35 | 30 | 40 | 20 |
| | Pigment ink | Optical | ⊚ | ◯ | ⊚ | ⊚ | ⊚ | ⊚ | ◯ |
| | | density | | | | | | | |
| | | Printing | ◯ | Δ | ◯ | ◯ | ⊚ | Δ | Δ |
| | | unevenness | | | | | | | |

| | | | | | | | |
|---|---|---|---|---|---|---|---|
| Dye ink optical density | Δ | ⊚ | Δ | ◯ | ◯ | Δ | ◯ |

| | | | Ex. 8 | Comp. Ex. 1 | Comp. Ex. 2 | Comp. Ex. 3 | Comp. Ex. 4 |
|---|---|---|---|---|---|---|---|
| Base | Loading filler | | Calcium | Calcium | Calcium | Calcium | Talc |
| paper | | | carbonate | carbonate | carbonate | carbonate | |
| | Ash content (% by mass) | | 15 | 20 | 20 | 13 | 15 |
| Pigment in | Collidal silica | Trade name | Quartron | Quartron | Quartron | Quartron | Quartron |
| the ink- | | | PL-5 | PL-2 | PL-10 | PL-5 | PL-5 |
| receiving | | Primary | 50 | 20 | 100 | 50 | 50 |
| layer | | particle | | | | | |
| | | diameter | | | | | |
| | | (nm) | | | | | |
| | | Secondary | 110 | 50 | 210 | 110 | 110 |
| | | particle | | | | | |
| | | diameter | | | | | |
| | | (nm) | | | | | |
| | | Ratio of | 2.2 | 2.5 | 2.1 | 2.2 | 2.2 |
| | | particle | | | | | |
| | | diameters | | | | | |
| | | Content | 60 | 60 | 60 | 60 | 60 |
| | | (parts) | | | | | |
| | Content of | Wet silica | 20 | 20 | 20 | 20 | 20 |
| | synthesized | Gas-phase | 20 | 20 | 20 | 20 | 20 |
| | amorphous | silica | | | | | |
| | silica (parts) | | | | | | |

| | | | | | | |
|---|---|---|---|---|---|---|
| Evaluation | Gloss at 20 degree | 30 | 20 | 30 | 25 | 25 |

| | | | | | | |
|---|---|---|---|---|---|---|
| Pigment ink | Optical | ◯ | X | ⊚ | Δ | Δ |
| | density | | | | | |
| | Printing | Δ | X | ◯ | X | X |
| | unevenness | | | | | |

| | | | | | |
|---|---|---|---|---|---|
| Dye ink optical density | Δ | ⊚ | X | Δ | Δ |

The data reported in Table 1 clearly indicated that the inkjet recording medium of each Example had excellent printability (optical density and no uneven printing) when the pigment ink was used, and also had excellent optical density when the dye ink was used.

In Example 8, the amount of calcium carbonate added to the base paper was lesser than those in other Examples, the unevenness upon printing with the pigment ink was therefore slightly increased, but there is no practical problem.

When Examples 5 and 6 using the same pigment are compared, the unevenness in Example 5 is better than that in Example 6 when the pigment ink was used. It would appear that the unevenness caused by aggregation of the color material on the surface of the ink-receiving layer is reduced, when the amount of the synthesized amorphous silica having excellent ink absorption performance is increased.

However, in Example 7, in which the amount of the synthesized amorphous silica was further increased and the amount of colloidal silica was further decreased, the gloss was decreased and the unevenness was increased. It would appear that, since the asperities on the surface of the ink-receiving layer were increased due to the lesser amount of colloidal silica, and as a result the unevenness was induced and the optical density was decreased. But there is no practical problem.

In summary, it is preferable that 30 to 70 parts of colloidal silica are added to the ink-receiving layer.

In contrast, in Comparative Example 1 in which the primary particle diameter of colloidal silica in the ink-receiving layer was under 30 nm, the pigment ink printability was significantly deteriorated. This may because minor cracks are produced on the surface of the coating layer and the coloring pigment in the pigment ink was dropped (poured) into the cracks.

In Comparative Example 2 in which the primary particle diameter of colloidal silica in the ink-receiving layer exceeded 70 nm, the optical density was significantly deteriorated, when the dye ink is used. This may because transparency of the ink-receiving layer was decreased.

In Comparative Example 3 in which the ash content of calcium carbonate in the base paper was under 15% by mass and in Comparative Example 4 in which no calcium carbonate was contained in the base paper, the pigment ink printability was deteriorated. It would appear that because the amount of calcium carbonate in the base paper was low (or zero), the binder was soaked nonuniformly from the coating color for the ink-receiving layer to produce the cracks on the surface of the ink-receiving layer,

Embodiments of the inkjet recording medium of the present invention using rosette type precipitated calcium carbonate as the loading filler for the base paper will be shown with the following Examples 9 to 16 and Comparative Examples 5 to 9.

### Example 9

Rosette type precipitated calcium carbonate (ALBACAR-5970 manufactured by SMI Inc.) was added in an ash content of 20% as a loading filler to a pulp slurry comprising 90 parts of bleached hard wood kraft pulp (L-BKP) and 10 parts of bleached soft wood kraft pulp (N-BKP) and having (Canadian standard freeness) freeness of 350 ml. 1.0 part of aluminum sulfate, 0.15 parts of AKD and 0.05 parts of a yield improving agent were further added thereto. The slurry was processed with a paper machine to make a base material. On the base material, 5% of starch and 0.2% of a surface sizing agent (AKD) were applied at a solid content of 1.5 g/m² to provide a base paper having a weight of 180 g/m².

The following coating color C was applied in the solid content of 15 g/m² to the base paper using a roll coater. During the coating layer was in a wet state, the following solidifying liquid D was applied to solidify the coating layer. Then, the coating layer was pressed to a heated specular finish surface via a press roll to take out the specular surface, thereby providing an ink-jet recording medium having a weight of 195 g/m².

Coating color C: A coating color having a concentration of 25% was prepared by mixing, as pigments, 60 parts of colloidal silica (Quartron PL-2: a trade name manufactured by Fuso Chemical Co., Ltd., having a primary particle diameter of 20 nm and a ratio of the secondary particle diameter to the primary particle diameter of 2.5), 20 parts of gas-phase synthesized amorphous silica (Aerosil 200V manufactured by Nippon Aerosil Co., Ltd.), 20 parts of wet synthesized amorphous silica (Fine Seal X-37B manufactured by Tokuyama Corporation); as a binder, 12 parts of poly(vinyl alcohol) (PVA224, a trade name manufactured by Kuraray Co., Ltd.); 1.5 parts of a fluorescent dye (BLANKOPHOR P liquid 01: a trade name manufactured by LANXESS K.K.); 0.5 parts of a mold release agent (Meikatex HP68: a trade name manufactured by Meisel Chemical Works, Ltd.); and 0.1 parts of an antifoaming agent (SN Defoamer 480: a trade name manufactured by San Nopco Ltd.).

Solidifying liquid D: A solidifying liquid was prepared by mixing 2% of borax, 4% of boric acid (mass ratio of borax/boric acid=1/2, calculated based on Na₂B₄O₇ and H₃BO₃ conversion), 0.2% of malic acid, 0.5 parts of a mold release agent (Meikatex HP68: a trade name manufactured by Meisei Chemical Works, Ltd.), and 0.01% of an antifoaming agent (SN Defoamer 480: a trade name manufactured by San Nopco Ltd).

### Example 10

An ink-jet recording medium was provided in the same manner described in Example 9 with the exception that rosette type precipitated calcium carbonate (ALBACAR-5970 manufactured by SMI Inc.) was added to change an ash content of 10%.

### Example 11

An ink-jet recording medium was provided in the same manner described in Example 9 with the exception that rosette type precipitated calcium carbonate (ALBACAR-5970 manufactured by SMI Inc.) was added to change an ash content of 5%.

### Example 12

An ink-jet recording medium was provided in the same manner described in Example 9 with the exception that rosette type precipitated calcium carbonate (ALBACAR-5970 manufactured by SMI Inc.) was added to change an ash content of 25%.

### Example 13

A coating color was prepared in the same manner described in Example 9 with the exception that colloidal silica (Quartron PL-5: a trade name manufactured by Fuso Chemical Co., Ltd., having a primary particle diameter of 50 nm and a ratio of the secondary particle diameter to the primary particle diameter of 2.2) was used in the coating color C in place of colloidal silica (Quartron PL-2: a trade name manufactured by Fuso Chemical Co., Ltd.), thereby providing an ink-jet recording medium.

### Example 14

A coating color was prepared in the same manner described in Example 9 with the exception that 40 parts of colloidal silica (Quartron PL-5: a trade name manufactured by Fuso Chemical Co., Ltd.) was used in place of colloidal silica (Quartron PL-2: a trade name manufactured by Fuso Chemical Co., Ltd.), the amount of wet synthesized amorphous silica (Fine Seal X-37B manufactured by Tokuyama Corporation) was changed to 50 parts, and the amount of gas-phase synthesized amorphous silica (Aerosil 200V manufactured by Nippon Aerosil Co., Ltd.) was changed to 10 parts in the coating color C, thereby providing an ink-jet recording medium.

### Example 15

A coating color was prepared in the same manner described in Example 9 with the exception that colloidal silica (Snowtex HS-M-20: a trade name manufactured by Nissan Chemical Industries, Ltd., spherical silica) was used in the coating color C in place of colloidal silica (Quartron PL-2: a trade name manufactured by Fuso Chemical Co., Ltd.), thereby providing an ink-jet recording medium.

### Example 16

A coating color was prepared in the same manner described in Example 9 with the exception that, as the pigments, 62 parts of alumina (AKP-G015: a trade name manufactured by Sumitomo Chemical Co., Ltd.) and 38 parts of pulverized silica (Sylojet 703C: a trade name manufactured by W. R. Grace & Co.) were added in place of colloidal silica (Quartron PL-2: a trade name manufactured by Fuso Chemical Co., Ltd.), wet synthesized amorphous silica (Fine Seal X-37B manufactured by Tokuyama Corporation) and gas-phase synthesized amorphous silica (Aerosil 200V manufactured by Nippon Aerosil Co., Ltd.), and a solidifying liquid was prepared by adding 3 parts of magnesium nitrate to the solidifying liquid D, thereby providing an ink-jet recording medium.

### Comparative Example 5

An ink-jet recording medium was provided in the same manner described in Example 9 with the exception that precipitated calcium carbonate (TP-121, a trade name manufactured by Okutama Kogyo Co., Ltd.) was added as the loading filler to the base paper in place of rosette type precipitated calcium carbonate (ALBACAR-5970 manufactured by SMI Inc.).

### Comparative Example 6

An ink-jet recording medium was provided in the same manner described in Example 9 with the exception that precipitated calcium carbonate (TP-121, a trade name manufactured by Okutama Kogyo Co., Ltd.) was added in an ash content of 5% as the loading filler to the base paper in place of rosette type precipitated calcium carbonate (ALBACAR-5970 manufactured by SMI Inc.).

### Comparative Example 7

An ink-jet recording medium was provided in the same manner described in Example 9 with the exception that talc (IRK-085: a trade name manufactured by Iriki Kaolin Corporation) was added in an ash content of 5% as the loading filler to the base paper in place of rosette type precipitated calcium carbonate (ALBACAR-5970 manufactured by SMI Inc.).

### Comparative Example 8

An ink-jet recording medium was provided in the same manner described in Example 9 with the exception that precipitated calcium carbonate (TP-121, a trade name manufactured by Okutama Kogyo Co., Ltd.) was added as the loading filler to the base paper in place of rosette type precipitated calcium carbonate (ALBACAR-5970 manufactured by SMI Inc.), and colloidal silica (Snowtex HS-M-20: a trade name manufactured by Nissan Chemical Industries, Ltd., spherical) was used in the coating color C in place of colloidal silica (Quartron PL-2: a trade name manufactured by Fuso Chemical Co., Ltd.).

### Comparative Example 9

An ink-jet recording medium was provided in the same manner described in Example 9 with the exception that, as the loading filler, precipitated calcium carbonate (TP-121, a trade name manufactured by Okutama Kogyo Co., Ltd.) was added to the base paper in place of rosette type precipitated calcium carbonate (ALBACAR-5970 manufactured by SMI Inc.), and the amount of wet synthesized amorphous silica (Fine Seal X-37B manufactured by Tokuyama Corporation) was changed to 80 parts, without adding colloidal silica (Quartron PL-2: a trade name manufactured by Fuso Chemical Co., Ltd.) in the coating color C.

### (Evaluation)

1. Printability with Pigment Ink

A predetermined pattern was recorded with the resulting inkjet recording medium using a pigment inkjet printer (PX-G900: a trade name manufactured by Seiko Epson Corporation), and was evaluated as follows:

1-1. Printing Clarity with Pigment Ink Printing (Optical Density)

Clarity on the predetermined pattern of the recorded image was visually evaluated. When the comprehensive evaluation result was A or above, there is no practical problem.

⊙: Very clear

### ◯: Clear

Δ: Slightly less clear
X: Not clear

### 1-2. Unevenness on the Pigment Ink Printed Area

The degree of the unevenness on the solid printed area was visually evaluated at four scales. The visually best (no unevenness) was ⊙, and the visually worst (significant unevenness) was X. When the evaluation result was Δ or more, there is no practical problem.

⊙: No unevenness
◯: Some unevenness

### Δ: Unevenness

X: Significant unevenness

### 2. Dye Ink Printability

Using a dye inkjet printer (PM-970C: a trade name manufactured by Seiko Epson Corporation), the degrees of bleeding at color boundaries on the solid printed area and the unevenness (on the solid printed area) in the resulting inkjet recording medium were visually evaluated at five scales. The visually best (no bleeding and no unevenness) was scale 5, and the visually worst (significant bleeding and unevenness) was scale 1. When the comprehensive evaluation result was A or above, there is no practical problem.

⊙: Scale 5 or more in the visual evaluation of both bleeding at color boundaries and unevenness on the solid printed area (no bleeding and no unevenness)
◯: Scale 4.5 in the visual evaluation of both bleeding at color boundaries and unevenness on the solid printed area (some bleeding or unevenness but no problems)
Δ: Scale 4 in the visual evaluation of either bleeding at color boundaries or unevenness on the solid printed area (bleeding or unevenness)
X: Scale 3.5 or less in the visual evaluation of either bleeding at color boundaries or unevenness on the solid printed area (significant bleeding and unevenness)

### 3. Image Clarity

The image clarity of the resulting inkjet recording medium was measured using an image clarity measuring device (Model: ICM-1DP manufactured by Suga Test Instruments, Co., Ltd.) according to JIS K7105. The measurement was conducted at measured angle of 60 degree and an optical comb width of 2 mm in an MD direction. When the image clarity is 50% or more, the reflected image is clearly transferred and has excellent gloss. When the image clarity is under 50%, the reflected image is not clearly transferred and has poor gloss.

4. Gloss at 20 degree

Gloss at 20 degree on the non-printed area of the surface of the ink-receiving layer in the resulting inkjet recording medium was measured according to JIS-Z8741. A gloss meter (True GLOSS GM-26PRO manufactured by Murakami Color Research Laboratory) was used for measurement. When the gloss at 20 degree was 10% or more, there is no practical problem.

The results obtained are shown in Tables 2 and 3.

TABLE 2

| | | | Ex. 9 | Ex. 10 | Ex. 11 | Ex. 12 | Ex. 13 | Ex. 14 | Ex. 15 | Ex. 16 |
|---|---|---|---|---|---|---|---|---|---|---|
| Base | Loading filler | | Rosette | Rosette | Rosette | Rosette | Rosette | Rosette | Rosette | Rosette |
| paper | | | type | type | type | type | type | type | type | type |
| | | | precipitated | precipitated | precipitated | precipitated | precipitated | precipitated | precipitated | precipitated |
| | | | calcium | calcium | calcium | calcium | calcium | calcium | calcium | calcium |
| | | | carbonate | carbonate | carbonate | carbonate | carbonate | carbonate | carbonate | carbonate |
| | Ash content (mass %) | | 20 | 10 | 5 | 25 | 20 | 20 | 20 | 20 |
| Pigment | Colloidal | Trade | Quartron | Quartron | Quartron | Quartron | Quartron | Quartron | Snow tex | — |
| in the ink- | silica | name | PL-2 | PL-2 | PL-2 | PL-2 | PL-5 | PL-5 | HSM 20 | |
| receiving | | Primary | 20 | 20 | 20 | 20 | 50 | 50 | 20 | — |
| layer | | particle | | | | | | | | |
| | | diameter | | | | | | | | |
| | | (nm) | | | | | | | | |
| | | Secondary | 50 | 50 | 50 | 50 | 110 | 110 | — | — |
| | | particle | | | | | | | | |
| | | diameter | | | | | | | | |
| | | (nm) | | | | | | | | |
| | | Ratio of | 2.5 | 2.5 | 2.5 | 2.5 | 2.2 | 2.2 | — | — |
| | | particle | | | | | | | | |
| | | diameters | | | | | | | | |
| | | Content | 60 | 60 | 60 | 60 | 60 | 40 | 60 | — |
| | | (parts) | | | | | | | | |
| | Content of | Wet silica | 20 | 20 | 20 | 20 | 20 | 50 | 20 | — |
| | other | Gas-phase | 20 | 20 | 20 | 20 | 20 | 10 | 20 | — |
| | pigment | silica | | | | | | | | |
| | (parts) | Pulverized | — | — | — | — | — | — | — | 38 |
| | | silica | | | | | | | | |
| | | Alumina | — | — | — | — | — | — | — | 62 |
| Evaluation | Pigment | Optical | ◯ | ◯ | Δ | ◯ | ⊚ | ⊚ | ◯ | Δ |
| | ink | density | | | | | | | | |
| | | Printing | ◯ | Δ | Δ | ◯ | ⊚ | ⊚ | Δ | ◯ |
| | | uneven- | | | | | | | | |
| | | ness | | | | | | | | |

| | | | | | | | | |
|---|---|---|---|---|---|---|---|---|
| Dye ink optical density | ⊚ | ⊚ | ⊚ | ⊚ | ⊚ | ⊚ | ⊚ | ⊚ |
| Gloss at 20 degree | 30 | 25 | 25 | 35 | 40 | 40 | 30 | 40 |
| Image clarity | 75 | 65 | 60 | 80 | 85 | 85 | 70 | 85 |

TABLE 3

| | | | Comp. Ex. 5 | Comp. Ex. 6 | Comp. Ex. 7 | Comp. Ex. 8 | Comp. Ex. 9 |
|---|---|---|---|---|---|---|---|
| Base | Loading filler | | Precipitated | Precipitated | Talc | Precipitated | Precipitated |
| paper | | | calcium | calcium | | calcium | calcium |
| | | | carbonate | carbonate | | carbonate | carbonate |
| | | | (Conventional) | (Conventional) | | (Conventional) | (Conventional) |
| | Ash content (mass %) | | 20 | 5 | 5 | 20 | 20 |
| Pigment in | Colloidal silica | Trade name | Quartron | Quartron | Quartron | Snow tex | — |
| the ink- | | | PL-2 | PL-2 | PL-2 | HSM 20 | |
| receiving | | Primary particle | 20 | 20 | 20 | 20 | — |
| layer | | diameter | | | | | |
| | | (nm) | | | | | |
| | | Secondary particle | 50 | 50 | 50 | — | — |
| | | diameter | | | | | |
| | | (nm) | | | | | |
| | | Ratio of particle | 2.5 | 2.5 | 2.5 | — | — |
| | | diameters | | | | | |
| | | Content (parts) | 60 | 60 | 60 | 60 | — |
| | Content of | Wet silica | 20 | 20 | 20 | 20 | 80 |
| | other pigment | Gas-phase silica | 20 | 20 | 20 | 20 | 20 |
| | (parts) | Pulverized silica | — | — | — | — | — |
| | | Alumina | — | — | — | — | — |
| Evaluation | Pigment ink | Optical density | Δ | X | X | Δ | X |
| | | Printing unevenness | Δ | X | X | X | X |

| | | | | | |
|---|---|---|---|---|---|
| Dye ink optical density | ◯ | ◯ | Δ | ◯ | ⊚ |
| Gloss at 20 degree | 25 | 20 | 20 | 20 | 15 |
| Image clarity | 55 | 40 | 40 | 40 | 35 |

| | | | |
|---|---|---|---|
| Examples having the same ash content | Ex. 9 | Ex. 11 | Ex. 9 |

The data reported in Table 2 clearly indicated that the inkjet recording medium of each Example had excellent printability (optical density and no uneven printing) when the pigment ink was used, and also had excellent optical density when the dye ink was used. In addition, each Examples had high gloss and excellent image clarity.

In Examples 9-12, only the ash contents were changed while the other conditions were the same. The higher the ash content is, the more the unevenness and the optical density are improved, when the pigment is used for printing.

In Examples 9, 13 and 14 in which peanut-shaped silica was used among Examples 9, 13-16 each having the same ash content, the evaluation results of both the unevenness and the optical density are ◯ when the pigment ink is used for printing, and these Examples are superior than other Examples (the evaluation results of either the unevenness or the optical density is Δ, when the pigment ink is used for printing).

In contrast, in Comparative Examples 5, 8 and 9 in which conventional precipitated calcium carbonate was used as the loading filler in the base paper at the ash content of 20% in place of rosette type precipitated calcium carbonate, the optical density and the unevenness are deteriorated when the pigment ink is used for printing, and the image clarity is decreased as compared with that in Example 9 in which the ash content was same.

In Comparative Examples 6 and 7 in which conventional precipitated calcium carbonate or talc was used as the loading filler in the base paper at the ash content of 5% in place of rosette type precipitated calcium carbonate, the gloss and the image clarity are decreased and the optical density and the unevenness are deteriorated when the pigment ink is used for printing, as compared with that in Example 11 in which the ash content was same.

In view of each Example, the gloss is preferably 25% or more, and the image clarity is preferably 60% or more.

Embodiments of the method for manufacturing the inkjet recording medium of the present invention will be shown with the following Examples 17 to 24 and Comparative Examples 10 to 16.

### Example 17

Precipitated calcium carbonate (TP-121, a trade name manufactured by Okutama Kogyo Co., Ltd.) was added in an ash content of 20% to a pulp slurry comprising 100 parts of bleached hard wood kraft pulp (L-BKP) having (Canadian standard freeness) freeness of 360 ml. 1.0 part of aluminum sulfate, 0.15 parts of AKD and 0.05 parts of a yield improving agent were further added thereto.

The slurry was processed with a paper machine to make a base material. On the base material, 5% of starch and 0.2% of a surface sizing agent (AKD) were applied at a solid content of 1.5 g/m² to provide a base paper having a weight of 180 g/m².

The following coating color E was applied in the solid content of 15 g/m² to the base paper using a roll coater. During the coating layer was in a wet state, the following solidifying liquid F was applied to solidify the coating layer. Then, the coating layer was pressed to a heated specular finish surface via a press roll to take out the specular surface, thereby providing an ink-jet recording medium having a weight of 195 g/m².

Coating color E: A coating color having a concentration of 25% was prepared by mixing, as the pigments, 40 parts of colloidal silica (Quartron PL-5: a trade name manufactured by Fuso Chemical Co., Ltd., having a primary particle diameter of 52 nm, a secondary particle diameter of 113 nm and a ratio of the secondary particle diameter to the primary particle diameter of 2.2), 10 parts of gas-phase synthesized amorphous silica (Aerosil 200V manufactured by Nippon Aerosil Co., Ltd.), 50 parts of wet synthesized amorphous silica (Fine Seal X-37B manufactured by Tokuyama Corporation); as a binder, 10 parts of poly(vinyl alcohol) (PVA224, a trade name manufactured by Kuraray Co., Ltd.); 1.5 parts of a fluorescent dye (BLANKOPHOR P liquid 01: a trade name manufactured by LANXESS K.K.); 0.5 parts of a mold release agent (Meikatex HP68: a trade name manufactured by Meisei Chemical Works, Ltd.); and 0.1 parts of an antifoaming agent (SN Defoamer 480: a trade name manufactured by San Nopco Ltd.).

Solidifying liquid F: A solidifying liquid was prepared by mixing 2% of borax, 4% of boric acid (mass ratio of borax/boric acid=1/2, calculated based on Na₂B₄O₇ and H₃BO₃ conversion), 0.2% of malic acid, 0.5 parts of a mold release agent (Meikatex HP68: a trade name manufactured by Meisei Chemical Works, Ltd.), 0.01% of a cationic aqueous urethane resin (CP-7030: a trade name manufactured by DIC corporation) and 0.01% of an antifoaming agent (SN Defoamer 480: a trade name manufactured by San Nopco Ltd).

### Example 18

An ink-jet recording medium was provided in the same manner described in Example 17 with the exception that the amount of the cationic aqueous urethane resin (CP-7030: a trade name manufactured by DIC corporation) was changed to 0.5% in the solidifying liquid F.

### Example 19

An ink-jet recording medium was provided in the same manner described in Example 17 with the exception that the amount of the cationic aqueous urethane resin (CP-7030: a trade name manufactured by DIC corporation) was changed to 1.0% in the solidifying liquid F.

### Example 20

The following coating color G was applied in the solid content of 5 g/m² to a support to form an underlayer. Then, the coating color E used in Example 17 was applied in the solid content of 15 g/m² thereto. During the coating layer was in a wet state, the solidifying liquid F used in Example 18 was applied to solidify the coating layer. Then, the coating layer was pressed to a heated specular finish surface via a press roll to take out the specular surface, thereby providing an ink-jet recording medium having a weight of 200 g/m².

Coating color G: A coating color having a concentration of 25% was prepared by mixing, as a pigment, 100 parts of precipitated silica (Fine Seal X-12 manufactured by Tokuyama Corporation); as binders, 10 parts of poly(vinyl alcohol) (PVA117, a trade name manufactured by Kuraray Co., Ltd.) and 10 parts of an ethylene vinyl acetate copolymer emulsion (AM-3150: a trade name manufactured by Showa Highpolymer Co., Ltd.) and 10 parts of a sizing agent (Polymaron 360: a trade name manufactured by Arakawa Chemical Industries Co., Ltd.).

### Example 21

An ink-jet recording medium was provided in the same manner described in Example 18 with the exception that 0.5% of the cationic aqueous urethane resin (CP-7020: a trade name manufactured by DIC corporation) was used in the solidifying liquid F in place of the cationic aqueous urethane resin (CP-7030: a trade name manufactured by DIC corporation).

### Example 22

An ink-jet recording medium was provided in the same manner described in Example 18 with the exception that 0.5% of the cationic aqueous urethane resin (CA-101: a trade name manufactured by DIC corporation) was used in the solidifying liquid F in place of the cationic aqueous urethane resin (CP-7030: a trade name manufactured by DIC corporation).

### Example 23

An ink-jet recording medium was provided in the same manner described in Example 18 with the exception that 0.5% of the cationic aqueous urethane resin (FD-25D: a trade name manufactured by Dai-ichi Kogyo Seiyaku Co., Ltd.) was used in the solidifying liquid F in place of the cationic aqueous urethane resin (CP-7030: a trade name manufactured by DIC corporation).

### Example 24

An ink-jet recording medium was provided in the same manner described in Example 18 with the exception that the following coating color H was used in place of the coating color E.

Coating color H: A coating color having a concentration of 25% was prepared by mixing, as pigments, 60 parts of colloidal silica (Quartron PL-2: a trade name manufactured by Fuso Chemical Co., Ltd., having a primary particle diameter of 23 nm, a secondary particle diameter of 51 nm and a ratio of the secondary particle diameter to the primary particle diameter of 2.2), 20 parts of gas-phase synthesized amorphous silica (Aerosil 200V manufactured by Nippon Aerosil Co., Ltd.), 20 parts of wet synthesized amorphous silica (Fine Seal X-37B manufactured by Tokuyama Corporation); as a binder, 10 parts of poly(vinyl alcohol) (PVA617, a trade name manufactured by Kuraray Co., Ltd.); 1.5 parts of a fluorescent dye (BLANKOPHOR P liquid 01: a trade name manufactured by LANXESS K.K.); 0.5 parts of a mold release agent (Meikatex HP68: a trade name manufactured by Meisei Chemical Works, Ltd.); and 0.1 parts of an antifoaming agent (SN Defoamer 480: a trade name manufactured by San Nopco Ltd.).

### Comparative Example 10

An ink-jet recording medium was provided in the same manner described in Example 17 with the exception that no cationic aqueous urethane resin was used in the solidifying liquid F.

### Comparative Example 11

An ink-jet recording medium was provided in the same manner described in Example 17 with the exception that 0.5% of the cationic acrylic resin (VINYBLAN 2580: a trade name manufactured by Nissin Chemical Industry, Co., Ltd.) was used in the solidifying liquid F in place of the cationic aqueous urethane resin.

### Comparative Example 12

An ink-jet recording medium was provided in the same manner described in Example 17 with the exception that 0.5% of polyvinyl alcohol (PVA117: a trade name manufactured by Kuraray Co., Ltd.) was used in the solidifying liquid F in place of the cationic aqueous urethane resin.

### Comparative Example 13

An ink-jet recording medium was provided in the same manner described in Example 17 with the exception that 0.5% of an ethylene vinyl acetate copolymer emulsion (AM-3150: a trade name manufactured by Showa Highpolymer Co., Ltd.) was used in the solidifying liquid F in place of the cationic aqueous urethane resin.

### Comparative Example 14

An ink-jet recording medium was provided in the same manner described in Example 17 with the exception that 0.5% of a plastic pigment (Ropaque HP15: a trade name manufactured by Rohm and Haas Company) was used in the solidifying liquid F in place of the cationic aqueous urethane resin.

### Comparative Example 15

An ink-jet recording medium was provided in the same manner described in Example 18 with the exception that 0.5% of colloidal silica (Quartron PL-3: a trade name manufactured by Fuso Chemical Co., Ltd.) was further added to the solidifying liquid F.

### Comparative Example 16

An ink-jet recording medium was provided in the same manner described in Example 17 with the exception that the amount of the cationic aqueous urethane resin (CP-7030: a trade name manufactured by DIC corporation) was changed to 1.1% in the solidifying liquid F.

### (Evaluation)

### 1. Inkjet Printability

A predetermined pattern was recorded with the resulting inkjet recording medium using a dye inkjet printer (PM-970C: a trade name manufactured by Seiko Epson Corporation), and was evaluated as follows:

### 1-1. Color Development

Clarity on the predetermined pattern of the recorded image was visually evaluated. When the comprehensive evaluation result was 0 or above, there is no practical problem.

: Very clear with high optical density

### ◯: Clear

Δ: Slightly less clear
X: Not clear with low optical density

### 1-2. Ink Absorption Performance

The degrees of bleeding (bleeding at color boundaries) and the unevenness (on the solid printed area) were visually evaluated at five scales (using evaluation sample). The visually best (no bleeding and no unevenness) was scale 5, and the visually worst (significant bleeding and unevenness) was scale 1. When the comprehensive evaluation result was ◯ or above, there is no practical problem.

⊙: Scale 5 or more in the visual evaluation of both bleeding at color boundaries and unevenness on the solid printed area (no bleeding and no unevenness)
◯: Scale 4.5 in the visual evaluation of both bleeding at color boundaries and unevenness on the solid printed area (some bleeding or unevenness but no problems)
Δ: Scale 4 in the visual evaluation of either bleeding at color boundaries or unevenness on the solid printed area (bleeding or unevenness)
X: Scale 3.5 or less in the visual evaluation of either bleeding at color boundaries or unevenness on the solid printed area (significant bleeding and unevenness)

### 2. Image Clarity

The image clarity of the resulting inkjet recording medium was measured using an image clarity measuring device (Model: ICM-1DP manufactured by Suga Test Instruments, Co., Ltd.) according to JIS K7105. The measurement was conducted at measured angle of 60 degree and an optical comb width of 2 mm in an MD direction. When the image clarity is 60% or more, the reflected image is clearly transferred and has excellent gloss. When the same is under 60%, the reflected image is not clearly transferred and has poor gloss.

### 3. Cast Operability

Continuous coating up to 10,000 m (the support was coated with the coating color, applied the solution containing the cationic urethane resin (and the solidifying agent), and was dried with the cast drum) was conducted to visually inspect whether the paper was broken or not and whether the surface of the cast drum was clouded or not. Evaluation was made according the following scales. When the evaluation result was ◯ or above, there is no problem in the operation.

⊙: The paper was not broken and the surface of the drum was entirely not clouded.
◯: The paper was not broken and the surface of the drum was slightly clouded, but there is almost no problem.
Δ: The paper was not broken but the surface of the drum was wholly clouded, and there is a problem.
X: The paper was broken (for example, the paper was taken by the drum).

The results obtained are shown in Table 4.

TABLE 4

| | | | | | Evaluation | | | |
|---|---|---|---|---|---|---|---|---|
| | | | | | | | Printability | |
| | | Solidifying liquid | | | | | | Ink |
| | | | | Content | Cast | Image | Color | absorption |
| | Under layer | Brand | Type | (% by mass) | operatibility | clarity | development | performance |
| Ex. 17 | None | CP-7030 | Cationic aqueous urethane resin | 0.01 | ⊚ | 64 | ◯ | ⊚ |
| Ex. 18 | None | CP-7030 | Cationic aqueous urethane resin | 0.5 | ⊚ | 80 | ◯ | ⊚ |
| Ex. 19 | None | CP-7030 | Cationic aqueous urethane resin | 1 | ◯ | 80 | ◯ | ◯ |
| Ex. 20 | Existed | CP-7030 | Cationic aqueous urethane resin | 0.5 | ◯ | 82 | ◯ | ◯ |
| Ex. 21 | None | CP-7020 | Cationic aqueous urethane resin | 0.5 | ◯ | 77 | ◯ | ◯ |
| Ex. 22 | None | CA-101 | Cationic aqueous urethane resin | 0.5 | ◯ | 66 | ◯ | ◯ |
| Ex. 23 | None | FD-25D | Cationic aqueous urethane resin | 0.5 | ◯ | 75 | ◯ | ◯ |
| Ex. 24 | None | CP-7030 | Cationic aqueous urethane resin | 0.5 | ⊚ | 70 | ⊚ | ⊚ |
| Comp. Ex. 10 | None | — | — | — | ⊚ | 56 | Δ | ◯ |
| Comp. Ex. 11 | None | Vinylolan 2580 | Cationic aqueous urethane resin | 0.5 | ◯ | 62 | X | X |
| Comp. Ex. 12 | None | PVA105 | Polyvinyl alcohol | 0.5 | X | 61 | X | X |
| Comp. Ex. 13 | None | AM-3150 | Ethylene vinylacetate copolymer | 0.5 | Δ | 58 | X | X |
| | | | emulsion | | | | | |
| Comp. Ex. 14 | None | Ropaque HP1055 | Plastic pigment | 0.5 | X | 85 | Δ | X |
| Comp. Ex. 15 | None | CP-7030 | Cationic aqueous urethane resin | 0.5 | X | — | — | — |
| | | PL-5 | Colloidal silica | 0.5 | | | | |
| Comp. Ex. 16 | None | CP-7030 | Cationic aqueous urethane resin | 1.1 | Δ | 77 | Δ | Δ |

The data reported in Table 4 clearly indicated that the inkjet recording medium of each Example according to the present invention had excellent printability (optical density and ink absorption performance), image clarity and cast operability. In Example 24, the pigment colloidal silica was changed to a colloidal silica having a small primary particle diameter, which resulted in slightly lower image clarity but higher printing quality those that in Example 18.

In contrast, in Comparative Example 10 in which no cationic aqueous urethane resin was used in the solidifying liquid F, the gloss on the surface of the ink-receiving layer was not sufficiently improved by the cast coating method and the image clarity was decreased. In Comparative Examples 11, 12 and 13 in which the cationic acrylic resin, polyvinyl alcohol and the ethylene vinyl acetate copolymer emulsion were used in the solidifying liquid F, respectively, in place of the cationic aqueous urethane resin, the image clarity was slightly improved compared with Comparative Example 10, but the printability was lowered. The results reveal that the printing quality can be improved by using the cationic aqueous urethane resin.

In Comparative Example 14 in which the plastic pigment was added in the solidifying liquid F in place of the cationic aqueous urethane resin, the image clarity was improved but the printability was poor.

In Comparative Example 15 in which the colloidal silica was added in the solidifying liquid F together with the cationic aqueous urethane resin, the colloidal silica was aggregated with the cationic urethane resin by the difference in ionic character, and no cast coating method was conducted.

In Comparative Example 16 in which over 1% of the cationic aqueous urethane resin was added in the solidifying liquid F, the coating layer was difficult to be released from the cast drum, the operability in the cast coating method was lowered and the printability was poor.

1. An inkjet recording medium comprising an ink-receiving layer containing a pigment and a binder formed on at least one side of a base paper containing calcium carbonate as a filler and pulp by a cast coating method, wherein the ash content of the calcium carbonate in the base paper is 15-30% by mass, and the ink-receiving layer contains colloidal silica as the pigment having a primary particle diameter of 30-70 nm and a ratio of the secondary particle diameter to the primary particle diameter of 1.5-3.0.

2. The inkjet recording medium according to claim 1, wherein the content of the colloidal silica is 20-80% by mass based on the total pigment in the ink-receiving layer.

3. The inkjet recording medium according to claim 1, wherein the calcium carbonate in the base paper is rosette type precipitated calcium carbonate and the ink-receiving layer has gloss of 10% or more at 20 degree measured according to JIS-Z8741.

4. The inkjet recording medium according to claim 2, wherein the calcium carbonate in the base paper is rosette type precipitated calcium carbonate and the ink-receiving layer has gloss of 10% or more at 20 degree measured according to JIS-Z8741.

5. A method for manufacturing an inkjet recording medium comprising the steps of: applying a coating color for an ink-receiving layer containing a pigment and a binder on at least one side of a base paper containing calcium carbonate as a filler and pulp to form a coating layer; applying an aqueous solution containing from 0.01% by mass to 1% by mass of a cationic urethane resin; and contacting the surface of the coating layer with a heated specular finish surface to form a gloss ink-receiving layer, wherein the ash content of the calcium carbonate in the base paper is 15-30% by mass, and the ink-receiving layer contains colloidal silica as the pigment having a primary particle diameter of 30-70 nm and a ratio of the secondary particle diameter to the primary particle diameter of 1.5-3.0.

6. The method according to claim 5, wherein the binder in the coating color for the ink-receiving layer contains poly(vinyl alcohol) and the aqueous solution further contains boric acid and/or borax.

7. The method according to claim 5, wherein the aqueous solution is applied to the coating layer in a wet state.

8. The method according to claim 6, wherein the aqueous solution is applied to the coating layer in a wet state.

9. The inkjet recording medium according to claim 3, wherein the ash content of the rosette type precipitated calcium carbonate in the base paper is 5-25% by mass measured according to JIS-P8251.

10. The inkjet recording medium according to claim 4, wherein the ash content of the rosette type precipitated calcium carbonate in the base paper is 5-25% by mass measured according to JIS-P8251.
